(19) United States
(12) Patent Application Publication
(10) Pub. No.: US 2026/0162152 A1
(43) Pub. Date: Jun. 11, 2026

(54) Property Assessment Method and System

(71) Applicant: David Barnett, Ballston Spa, NY (US)

(72) Inventor: David Barnett, Ballston Spa, NY (US)

(21) Appl. No.: 19/319,756

(22) Filed: Sep. 5, 2025

Related U.S. Application Data
(60) Provisional application No. 63/690,852, filed on Sep. 5, 2024.

(51) Int. Cl. G06Q 30/02; G06Q 50/163

(52) U.S. Cl. CPC G06Q 30/0278; G06Q 50/163

(57) ABSTRACT

A computer-implemented method and system for managing real property assessment data is disclosed. The system comprises a synchronization tool, integration compute, and transformation logic on a user's device. It utilizes local Real Property System (RPS) or Computer-Assisted Mass Appraisal (CAMA) databases. The system incorporates machine learning algorithms and data normalization techniques to improve data accuracy and consistency in property value assessment. The system may further include user interfaces for data input and reporting, as well as connectivity features for remote database access.

### CROSS-REFERENCE TO RELATED APPLICATIONS

This application claims priority to U.S. Provisional Patent Application Ser. No. 63/690,852, filed on Sep. 5, 2024, the entire disclosure of which is hereby incorporated herein by reference.

### BACKGROUND

The management and dissemination of real property assessment data are pivotal functions for municipalities. Efficient handling and public accessibility of this data enhance transparency and accessibility. Traditionally, municipalities have relied on paper documents and in-person updates, which can be time-consuming and resource-intensive. Additionally, the lack of real-time data updates can lead to outdated information being available to the public, thereby hindering informed decision-making.

Existing technologies for managing property assessment data often lack comprehensive online access capabilities and integrative features that streamline data management. Many systems in use require physical presence for updates or are not equipped to handle continuous data updates effectively. Moreover, these conventional systems do not typically offer functionalities such as image uploads or customizable interfaces tailored to specific municipal needs, limiting their utility for diverse user groups.

Further, the security measures in many legacy systems are not adequate to protect sensitive real property assessment data, raising concerns over data breaches and unauthorized access. The need for secure, web-based platforms that ensure complete data protection through encryption, secure user authentication, and role-based access control remains unmet. Additionally, the inability to support mobile access restricts users'capability to interact with the system while in the field, thereby limiting operational flexibility and responsiveness.

What is needed is a comprehensive, subscription-based online interface that allows municipalities to efficiently manage and update real property assessment data in a secure and accessible manner. This solution should incorporate functionalities such as mobile access, seamless integration with existing databases, customizable user interfaces, advanced search capabilities, and data security measures. Moreover, it should enable automated data backups and provide user training and support to ensure effective utilization of the system. This would fill a significant gap in the current market by providing municipalities with a robust and flexible tool to enhance the delivery of property assessment data to the public.

### FIELD

The present technology pertains to a subscription-based online interface, referred to as Property Record On-line System (PROS), designed for municipalities to facilitate the delivery, updating, and access of real property assessment data to the public. Key aspects of this system include online data access, data update capabilities, photograph integration, customizable interface elements, subscription management, database integration, data security, user training, automated backup, mobile access, advanced search functionality, and reporting and analytics tools.

### SUMMARY

In one aspect, the Property Record On-line System (PROS) provides municipalities with an online platform designed to deliver and update real property assessment data to the public. The system utilizes standard web-based technologies to ensure accessibility and reliability in the dissemination of property information.

One object of the technology is to increase the efficiency of property assessment data management by reducing reliance on physical documents and in-person updates. This objective is achieved by enabling authorized users to update assessment data from any location, thus enhancing the flexibility and usability of the system.

In yet another aspect, the subscription-based model of PROS allows municipalities to budget predictably for continuous updates, maintenance, and support, ensuring that the system remains operational and up-to-date over time. This form of operation provides a sustainable financial model for municipalities.

Another object of the technology is to improve the quality and comprehensiveness of property information provided to the public. This is facilitated by the capability of users to upload photographs of properties, thereby offering visual representations alongside textual data.

In an embodiment, PROS integrates with existing assessment databases such as the New York State Real Property System Version 4 (NYS RPSV4), ensuring compatibility with existing datasets. This integration simplifies the transition to the online system and minimizes the need for extensive data conversion efforts.

In yet another embodiment, data security measures within PROS, including encrypted data transmission, secure user authentication, and role-based access control, ensure that property assessment data is protected against unauthorized access and potential data breaches. This safeguarding of data is fundamental to maintaining the integrity of the system.

In another aspect, PROS offers customizable homepages, allowing municipalities to tailor the interface to their specific needs. This customization enables the presentation of unique and relevant information, enhancing the user experience for both the public and municipal employees.

One object of the technology is to streamline the retrieval of property assessment data through advanced search functionalities. Users may locate specific data using various parameters such as property address, owner name, and assessment value, thus facilitating quick and efficient access to relevant information.

In a further aspect, PROS includes reporting and analytics tools that assist municipalities in generating detailed reports and analyzing property assessment data. These tools provide valuable insights, enabling informed decision-making based on the assessment data available within the system.

In another embodiment, PROS features automated backup and recovery functionality. Regular automated backups and a recovery mechanism ensure that data integrity is maintained, providing a safeguard against data loss or system failures.

In yet another embodiment, PROS is optimized for mobile devices, enabling authorized users to access and update data via smartphones and tablets. This mobile accessibility increases convenience for users who require data access while in the field.

In another aspect, PROS includes user training and support features, such as instructional videos, step-by-step guides, and live support options. These elements facilitate the effective use of the system by providing comprehensive assistance to users.

In an embodiment, PROS allows municipalities to present municipality-specific information through a customizable homepage. This feature ensures that relevant and unique information pertinent to each municipality is easily accessible to users.

In yet another embodiment, the system's photograph upload capability enhances the comprehensiveness of the data presented by allowing visual representations of properties. This feature aids in providing a more detailed and informative view of the properties being assessed.

In one embodiment, the present disclosure provides a computer-generated method comprising: receiving, by a user's machine or a user's device, user data; responsive to receiving the user data, by the user's machine or the user's device, an assessment sync tool initiates a request to an assessment data factory; responsive to receiving the request, the assessment data factory begins an assessment pipeline; requesting, by the assessment pipeline, the user data from the user's machine or the user's device; receiving, by the assessment pipeline, the user data from the user's machine or the user's device; responsive to receiving the user data from the assessment pipeline, an integration compute integrates the user data and initiates a query to an assessment database requesting public assessment data of a real property parcel; responsive to receiving the user data and the public assessment data, the integration compute initiates integration logic; generating, by the integration logic, integrated assessment data; responsive to receiving integrated assessment data, the assessment pipeline initiates transformation logic, generating transformed assessment data; uploading, by the assessment pipeline, to an assessment server, the transformed assessment data; generating, by the assessment server, a transformer assessment record; and, responsive to receiving, from the assessment server, an assessment database stores the transformed assessment record.

### BRIEF DESCRIPTION OF THE DRAWINGS

FIG. 1 is a flowchart depicting the PROS upload process, illustrating the interaction between local RPS or CAMA data, the user's machine, Azure® Data Factory, and Azure® SQL Database.

FIG. 2 is a flowchart illustrating the process of managing property data through various stages, including data entry, file uploads, database storage, and review actions within a system utilizing Azure® SQL Cloud Database and Azure® Data Storage.

### DETAILED DESCRIPTION

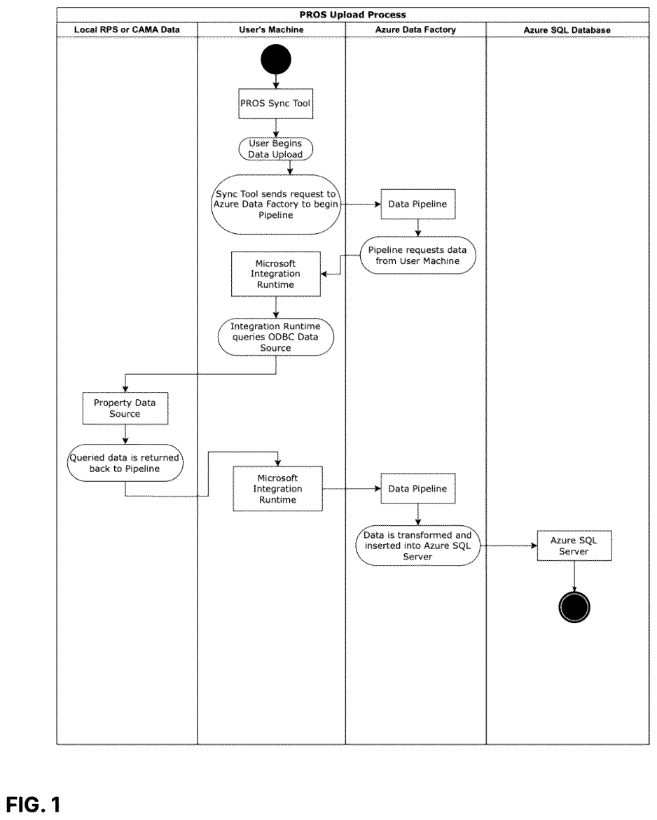

FIG. 1 shows an illustration of the PROS upload process. The illustration is divided into four columns: Local RPS or CAMA Data, User's Machine, Azure® Data Factory, and Azure® SQL Database.

A local Real Property System (RPS) is a database managed by local assessment offices that stores comprehensive records about parcels within a municipality. It typically includes ownership, property address, parcel IDs, legal descriptions, assessed value, sales history, building characteristics, exemption status, and tax roll information. Local RPS data powers the administrative and valuation functions for property tax assessment and is the source behind assessment rolls, public searchable property maps, and official records.

Computer-Assisted Mass Appraisal (CAMA) is both a methodology and a software system for mass property appraisal. Local CAMA databases store extensive property and market data, such as building size and condition, land attributes, recent sales, market trends, income and expense data for commercial properties, and valuation formulas. CAMA data is processed by algorithms to automate and standardize property valuations across many parcels efficiently. It allows for data verification, integration with GIS/parcels, exemption reviews, and produces reports for assessment staff, appeals, and compliance with regulations

A User's Machine includes any desktop computer, laptop computer, workstation, tablet, or convertible PC, or any other suitable device that is capable of allowing a user to upload data.

The PROS Sync Tool is a data synchronization tool, in particular, software or logic that ensures data consistency and uniformity across multiple systems, devices, or locations by continuously updating and harmonizing data between them, thereby enabling real-time collaboration and accurate decision-making by access to the latest user data.

User Data includes any parcel data that can be used to assess the value of a property. It can include: location data such as neighborhood quality, crime rates, proximity to amenities (schools, hospitals, parks), and overall desirability of area, zoning classification, legal use, and whether the property is in a flood zone or subject to other hazards; Physical Characteristics such as lot size and topography (shape and slope of land), building size: Square footage, number of rooms, bedrooms, bathrooms, construction quality: materials used, workmanship, foundation type and condition, roof and exterior walls, age and condition: well-maintained homes often receive higher appraisals; evidence of wear or deferred maintenance can lower value; Improvements & Amenities such as renovations, upgrades, or additions made to the property, features such as pools, patios/decks, basement (finished or unfinished), attic, garage, energy-efficient systems, fireplaces, appliances; Comparable Properties (“Comps”), sale prices of recently sold properties with similar characteristics in the area, adjustments are made for differences in features, age, and condition; Market Conditions such local and national real estate trends, supply and demand, interest rates, and buyer confidence; Site Conditions such as utilities access (water, sewer, electricity, gas), access roads, presence of sidewalks, curbs, and overall site accessibility; Legal and Regulatory Factors including any easements, encroachments, special regulations, or restrictions; and, Special Factors which may include curb appeal, landscaping, pest or structural damage, storage space. It is understood that the preceding list is illustrative and not to be taken as exhaustive. User Data may include any parcel data that is helpful in assessing the value of a property.

Microsoft Integration Runtime is the compute infrastructure used by Azure® Data Factory and Azure® Synapse pipelines to perform data integration tasks. It acts as the engine that provides capabilities such as data movement, data transformation, and activity dispatch across different network environments.

An ODBC Data Source refers to a set of connection information that allows applications to access data stored in external databases using the ODBC (Open Database Connectivity) standard. In practice, an ODBC datasource is defined by a “Data Source Name” (DSN), which includes details such as the type of database, location/server address, database name, user credentials, and the relevant ODBC driver settings needed to communicate with the data source. ODBC datasources are managed through tools like the ODBC Data Source Administrator, enabling easy creation, modification, or deletion of connection settings as needed for databases and application

Azure® Data Factory is a cloud-based data integration service provided by Microsoft® used for building, orchestrating, and automating ETL (Extract, Transform, Load) workflows at scale. It enables organizations to move, transform, and integrate data from various sources—such as on-premises databases, cloud storage, SaaS applications, or big data platforms—into a unified, actionable format for analytics, business intelligence, or further processing

Azure® SQL Server refers to a suite of managed SQL database services provided by Microsoft® and running in the Azure® cloud, leveraging the SQL Server database engine.

Azure® SQL Database is a fully managed, cloud-based relational database service built on Microsoft® SQL Server technology.

It is noted that while the system of the present disclosure preferably operates within the Microsoft® ecosystem, other ecosystems may also work. For example, rather than Microsoft Integration Runtime, a different system for data integration may be used. It is also understood that rather than Azure® Data Factory, Azure® SQL Server, and Azure® SQL Database, any suitable data integration service, server, or database can be substituted.

Within the User's Machine column, the process begins with the PROS Sync Tool, which is represented by a dark-colored circle. Below the PROS Sync Tool, the flowchart indicates a “User Begins Data Upload” step, which triggers the data upload sequence. The PROS Sync Tool then sends a request to the Azure® Data Factory to begin the pipeline. This is indicated by an arrow pointing to the Azure® Data Factory column, where the Data Pipeline step is located.

In the Azure® Data Factory column, the Data Pipeline requests data from the User Machine. This process is depicted with an arrow pointing back to the User's Machine column, where the Microsoft Integration Runtime is engaged. The Microsoft Integration Runtime queries the ODBC Data Source, an action marked by another arrow pointing towards the Property Data Source located in the Local RPS or CAMA Data column.

The queried data is then returned back to the Data Pipeline in the Azure® Data Factory column, as represented by an arrow looping back to the Microsoft Integration Runtime in the User's Machine column and then to the Data Pipeline. Following this retrieval, the Data Pipeline ensures that the data is transformed and inserted into the Azure® SQL Server, which is depicted by an arrow pointing towards the Azure® SQL Database column, culminating the process.

Lastly, the Azure® SQL Server securely holds the transformed data, as indicated by a dark-colored circle under the Azure® SQL Database column. This flowchart effectively elucidates the sequential steps involved in the PROS upload process, illustrating the interaction between various modules and data repositories.

The system relies on Sync Tools, APIs, Data Factories, Databases, Integrations, Data Sources, Pipelines, to transform the raw data into a useable format suitable for displaying by a server.

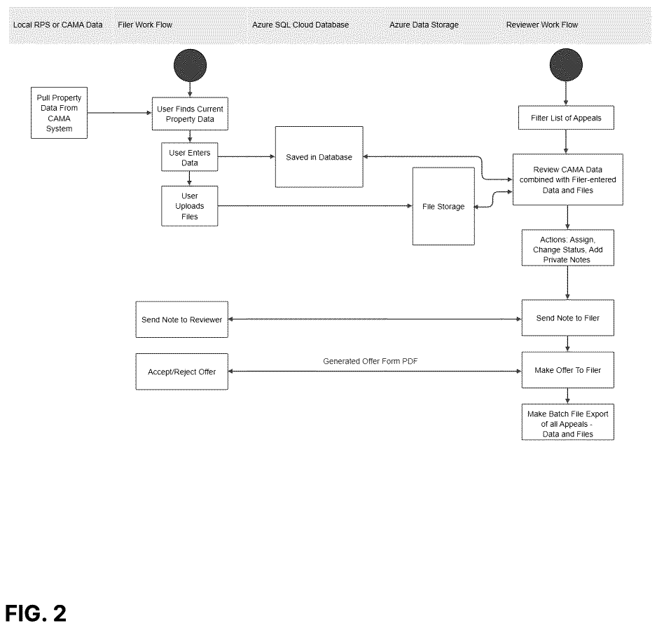

FIG. 2 shows a flowchart illustrating a system for managing real property assessment data, comprising multiple workflows and data interactions. The process begins with the “Local RPS or CAMA Data” section, where property data is pulled from a CAMA system. This data is then utilized in the “Filer Work Flow,” where the user finds current property data and enters additional data. The user also uploads files, which are subsequently saved in an “Azure® SQL Cloud Database.”

The saved data and files are stored in “Azure® Data Storage,” facilitating further processing. The “Reviewer Work Flow” begins with filtering a list of appeals. The reviewer examines CAMA data combined with filer-entered data and files, allowing for actions such as assigning tasks, changing statuses, and adding private notes. The reviewer can send notes back to the filer, and offers can be made to the filer based on the reviewed data.

The system generates an offer form PDF, which is sent to the filer, who can accept or reject the offer. Additionally, the system allows for batch file export of all appeals, including data and files, ensuring comprehensive data management and accessibility. This flowchart effectively demonstrates the integration and interaction between various components, including local databases, cloud storage, and user interfaces, to streamline property assessment processes.

### Benefits and Features

The method and system of the current disclosure offers property owners, property assessors, and other users broad capabilities for searching property assessment data including, but not limited to, the ability to search:
Jurisdiction/County-wide and town level data
Commercial sales records
Comparable properties
Adjustment grids
Mapping capabilities
Historical parcel deeds information management
Tax details
NYS Judicial Security Act compliance

### EXAMPLE

### Example 1

The property assessment method and system is useful in many settings. In particular, the system can be used in the case that a property owner wants to appeal the determination of the assessed value of their property. This can be very important for tax determination purposes. In some cases, a municipality will value a parcel much higher than what the property owner believes the property is worth. In this case, the property owner may go through a grievance process whereby the municipality is asked to reassess the value of the property. As an example, New York State has a formal grievance process, which is referred to as Grievance Day and is conducted through the Board of Assessment Review (hereinafter “BAR”) if possible.

In this instance, the property assessment method and system may include functionality that is customized to a municipal appeal process. The functionality may be referred to as a power appeal system. In this embodiment, the power appeal system is a multi-tenant application that allows property owners to make an appeal during an appeal window, and property assessors to review that appeal. Property owners can search for their property data from the local RPS or other CAMA system and start an appeal. From there, the property owners request a new assessment value and fill out a series of forms and upload files to provide support for the requested adjustment of the property assessment.

Property assessors then have access to a table where they can search, sort, and filter by many datapoints (including, but not limited to, filer and owner info, property attributes, current values, and requested values). Property assessors have a number of actions available to them, including change status (individually or in bulk), assign properties (individually or in bulk), add files, send notes back and forth to property owners or other property assessors, and make an offer.

Making an offer generates a PDF settlement letter with the offer values. Property owners can choose to reject or accept this letter, which adds their name to the bottom of the letter. Property assessors can then also export the review information as a customized csv or a zip that includes a folder for each appeal containing a generated pdf of appeal data and any attached files. The application also includes features like appeals that can be automatically assigned to a property assessor by zip code upon submission.

It will be appreciated by those skilled in the art that while the property assessment method and system has been described in detail herein, the invention is not necessarily so limited and other examples, embodiments, uses, modifications, and departures from the embodiments, examples, uses, and modifications may be made without departing from the process and all such embodiments are intended to be within the scope and spirit of the appended claims.

1. A computer-generated method comprising:
receiving, by a user's machine or a user's device, user data;
responsive to receiving the user data, by the user's machine or the user's device, an assessment sync tool initiates a request to an assessment data factory;
responsive to receiving the request, the assessment data factory begins an assessment pipeline;
requesting, by the assessment pipeline, the user data from the user's machine or the user's device;
receiving, by the assessment pipeline, the user data from the user's machine or the user's device;
responsive to receiving the user data from the assessment pipeline, an integration compute integrates the user data and initiates a query to an assessment database requesting public assessment data of a real property parcel;
responsive to receiving the user data and the public assessment data, the integration compute initiates integration logic;
generating, by the integration logic, integrated assessment data;
responsive to receiving integrated assessment data, the assessment pipeline initiates transformation logic, generating transformed assessment data;
uploading, by the assessment pipeline, to an assessment server, the transformed assessment data;
generating, by the assessment server, a transformer assessment record; and,
responsive to receiving, from the assessment server, an assessment database stores the transformed assessment record.

2. The computer-generated method of claim 1, wherein the sync tool is on the user's machine or the user's device.

3. The computer-generated method of claim 2, wherein the Integration compute is on the user's machine or the user's device.

4. The computer-generated method of claim 3, wherein the Integration logic is on the user's machine or the user's device.

5. The computer-generated method of claim 4, wherein user data includes any data that pertains to a parcel and that can be used to assess the value of a property.

6. The computer-generated method of claim 5, wherein public assessment data includes any pubic domain data that pertains to a parcel and that can be used to assess the value of a property.

7. The computer-generated method of claim 1, wherein the assessment database is a local RPS Database.

8. The computer-generated method of claim 6, wherein the assessment database is a local RPS Database.

9. The computer-generated method of claim 1, wherein the assessment database is a CAMA Database.

10. The computer-generated method of claim 6, wherein the assessment database is a CAMA Database.

11. The computer-generated method of claim 7, wherein user data includes any data that pertains to a parcel and that can be used to assess the value of a property.

12. The computer-generated method of claim 11, wherein public assessment data includes any pubic domain data that pertains to a parcel and that can be used to assess the value of a property.

13. The computer-generated method of claim 9, wherein user data includes any data that pertains to a parcel and that can be used to assess the value of a property.

14. The computer-generated method of claim 13, wherein public assessment data includes any pubic domain data that pertains to a parcel and that can be used to assess the value of a property.

15. A system for managing real property assessment data, comprising:
a user interface configured to receive user data from a user's machine or a user's device;
an assessment sync tool operatively coupled to the user interface, the assessment sync tool configured to initiate a request to an assessment data factory upon receiving the user data;
an assessment data factory configured to begin an assessment pipeline in response to the request from the assessment sync tool;
an integration compute module configured to integrate the user data and initiate a query to an assessment database for public assessment data of a real property parcel;
integration logic configured to generate integrated assessment data from the user data and the public assessment data;
transformation logic configured to generate transformed assessment data from the integrated assessment data;
an assessment server configured to receive the transformed assessment data and generate a transformer assessment record; and
an assessment database configured to store the transformed assessment record received from the assessment server.

16. The system of claim 15, wherein the user interface is further configured to allow customization of the display layout to accommodate specific municipal requirements.

17. The system of claim 15, wherein the assessment sync tool is further configured to perform data validation checks on the user data prior to initiating the request to the assessment data factory.

18. The system of claim 15, wherein the integration compute module is further configured to utilize machine learning algorithms to enhance the accuracy of the integrated assessment data.

19. The system of claim 15, wherein the transformation logic is further configured to apply data normalization techniques to ensure consistency across the transformed assessment data.

20. The system of claim 15, wherein the assessment server is further configured to generate analytics reports based on the transformed assessment data for municipal decision-making purposes.
